(19) United States
(12) Patent Application Publication
(10) Pub. No.: US 2010/0058933 A1
(43) Pub. Date: Mar. 11, 2010

(54) Wine aerator

(76) Inventor: Peter S. Cheng, Tsing Yi (HK)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/283,330

(22) Filed: Sep. 11, 2008

(51) Int. Cl. B01F 3/04

(52) U.S. Cl. 99/323.1

(57) ABSTRACT

A device for aerating wine in a bottle has an elongated, upright conduit with one end region immersed in the wine, and an opposite end region exposed to the atmosphere. A rotary shaft is located within, and extends along, the conduit. A wine blade is mounted on the shaft for drawing the wine as a wine flow into the one end region in an upward direction toward the opposite end region of the conduit upon rotation of the shaft. An air blade is preferably mounted on the shaft for causing the air to move as an air stream into the opposite end region in a downward direction toward the one end region of the conduit upon rotation of the shaft. A drive rotates the shaft, the wine blades and the air blades to propel the wine flow and the air stream against each other in a mutually countercurrent relationship and to commingle the wine flow and the air stream inside the bottle.

### BACKGROUND OF THE INVENTION

This invention generally relates to the aeration or decanting of liquids stored in containers and, more particularly, to a device for, and a method of, aerating wine in bottles.

To enjoy the bouquet and flavor of a fine wine, wine connoisseurs knew that the wine should be allowed to aerate or “breathe” before human consumption. Heretofore, this was done by merely opening a bottle of wine and allowing the wine to interact with the atmosphere in order to oxidize certain chemicals, such as tannins, naturally contained in the wine, which would otherwise impair the taste of the wine. This was a time consuming operation and needed to be performed well in advance of consumption of the wine. Wine was also conventionally aerated by manually decanting the wine from the wine bottle to another container. Here again, this transfer operation was time consuming and required not only a separate decanter, but also a steady hand to avoid wine spillage.

In order to expedite the breathing time of wine just before serving, the art has proposed, for example, in U.S. Pat. No. 5,595,104 and U.S. Pat. No. 4,494,452, devices for pumping air under pressure into the bottled wine. However, pressurized air generated foam, and a foamed wine was distasteful. U.S. Pat. No. 6,508,163 proposed the pumping of wine outside the bottle for exposure to the atmosphere, whereupon the exposed wine returned under the influence of gravity to the bottle. Although generally satisfactory for its intended purpose, the gravity return was a time-consuming procedure and, in any event, the wine was not sufficiently aerated.

### SUMMARY OF THE INVENTION

One aspect of this invention is directed to a portable aeration device for aerating wine in a bottle. The device includes an elongated, upright, hollow conduit having one end region immersed in the wine to be in fluid communication with the wine, and an opposite end region exposed to the atmosphere to be in fluid communication with the atmosphere. A rotary shaft is located within, and extends along, the conduit. A set of wine blades, preferably configured as a single, continuous, spiral blade, is mounted on the shaft inside the conduit for drawing the wine as a wine flow into the one end region in an upward direction toward the opposite end region of the conduit upon rotation of the shaft. A set of air blades, including a single blade, is preferably mounted on the shaft inside the conduit for causing the air to move, by pushing or pulling, as an air stream into the opposite end region in a downward direction toward the one end region of the conduit upon rotation of the shaft. A drive, preferably a single battery-operated motor, is operative for rotating the shaft, the wine blades and the air blades to propel the wine flow and the air stream against each other in a mutually countercurrent relationship and to commingle the wine flow and the air stream inside the bottle.

In a preferred embodiment, the conduit has apertures located intermediate the end regions of the conduit, and a set of fins is mounted on the shaft intermediate the end regions of the conduit. The fins are rotatable with the shaft for radially directing the wine flow by centrifugal force through the apertures as wine droplets for commingling with the air stream.

In addition, the conduit extends from a housing having an annular mounting flange for mounting within a neck of the bottle with a friction fit to support the housing in a stable position on the bottle. The housing has at least one air inlet, and preferably a plurality of air inlets, and at least one air outlet, and preferably a plurality of air outlets to admit and discharge air respectively in and out of the bottle. The inlets and outlets are spaced apart from one another.

Another aspect of this invention is directed to a method of aerating wine in a bottle by performing the steps of immersing one end region of an elongated, upright conduit to be in fluid communication with the wine, by exposing an opposite end region of the conduit to be in fluid communication with the atmosphere, by locating a rotary shaft within, and by extending the shaft along, the conduit, by drawing the wine as a wine flow into the one end region in an upward direction toward the opposite end region of the conduit upon rotation of a wine blade mounted on the shaft, by preferably causing the air to move as an air stream into the opposite end region in a downward direction toward the one end region of the conduit upon rotation of an air blade mounted on the shaft, and by rotating the shaft, the wine blade and the air blade to propel the wine flow and the air stream against each other in a mutually countercurrent relationship and to commingle the wine flow and the air stream inside the bottle.

Thus, this invention does not wait for the wine to passively interact with the atmosphere, and does not require one to manually decant the wine from the wine bottle to another container, but instead, expedites the aeration of wine in situ within the wine bottle by affirmatively forcing the wine flow and the air stream in countercurrent directions against each other, thereby achieving an intimate, rapid and efficient commingling of the air and the wine. The use of the rotating fins is particularly advantageous since they effectively scatter the wine into droplets and greatly increase the effective surface area between the air and the individual droplets. The device is readily portable and has a small footprint.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a broken-away, perspective view showing the aeration device in accordance with this invention mounted on a wine bottle;

FIG. 2 is a sectional view taken on the line 2-2 of FIG. 1;

FIG. 3 is a sectional view taken on the line 3-3 of FIG. 2:

FIG. 4 is a sectional view taken on the line 4-4 of FIG. 2;

FIG. 5 is a sectional view taken on the line 5-5 of FIG. 2; and

FIG. 6 is a sectional view taken on the line 6-6 of FIG. 2.

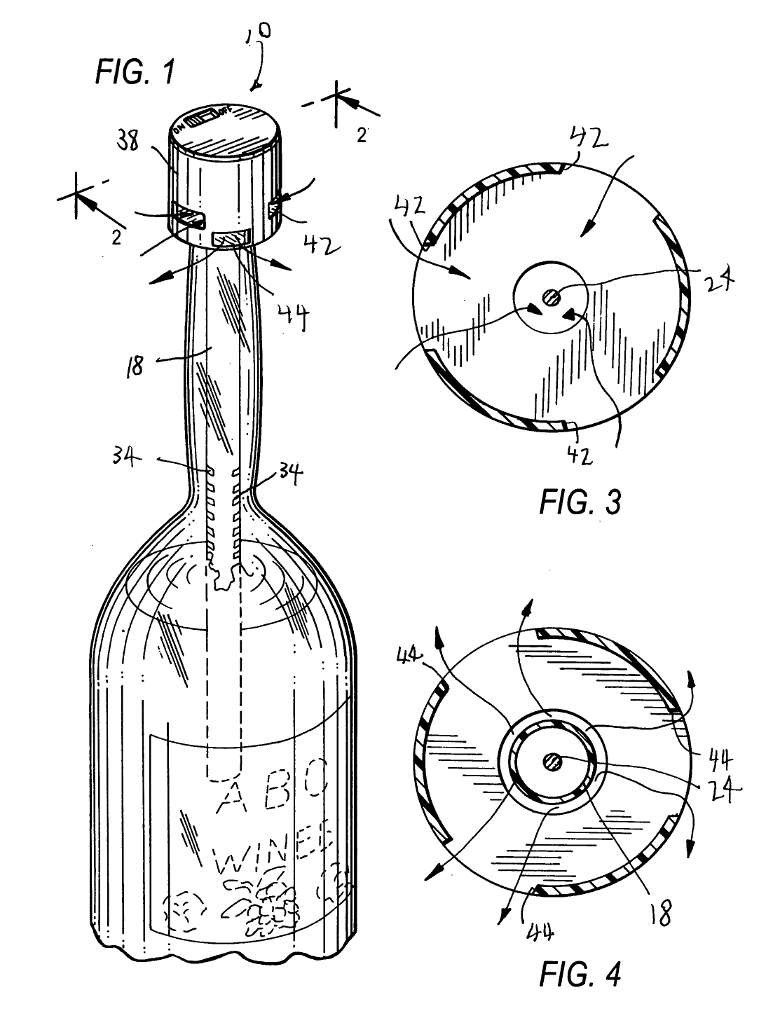

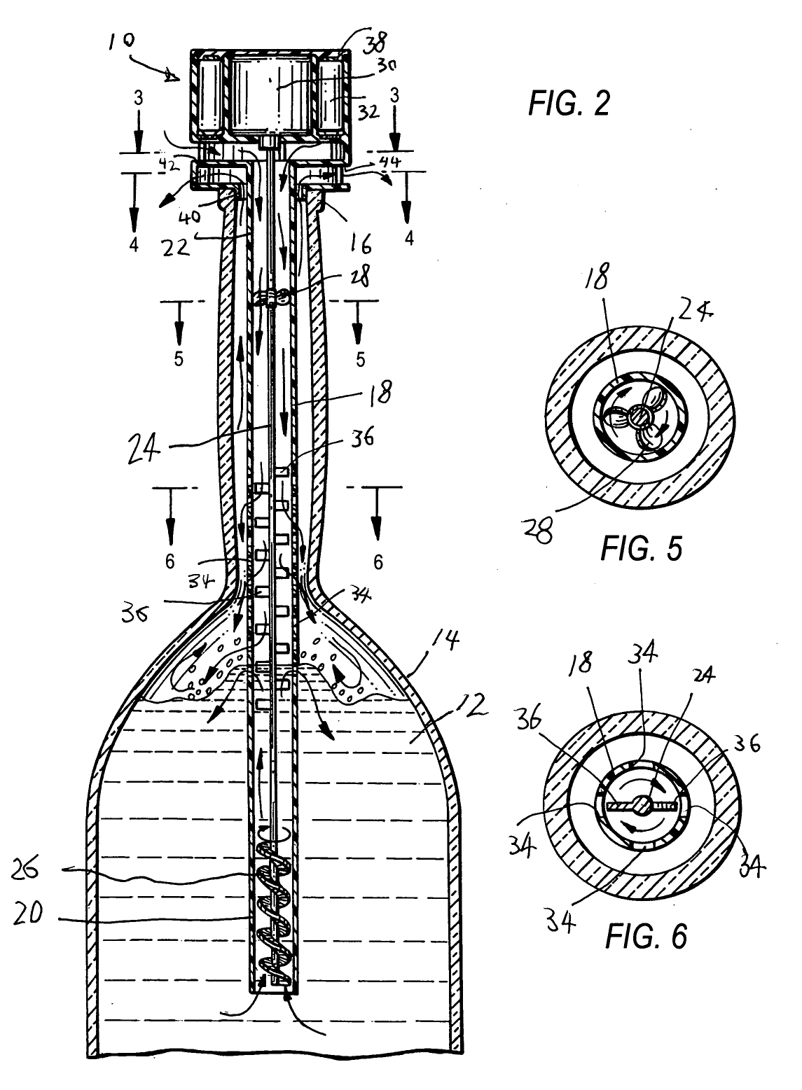

### DETAILED DESCRIPTION OF THE PREFERRED EMBODIMENTS

Referring now to the drawings, reference numeral 10 generally identifies a portable aeration device for aerating wine 12 in a bottle 14 having a neck 16. The device 10 includes an elongated, upright, hollow conduit 18 having one or lower end region 20 immersed in the wine 12 to be in fluid communication with the wine 12, and an opposite or upper end region 22 exposed to the atmosphere to be in fluid communication with the atmosphere.

A rotary shaft 24 is located within, and extends along, the conduit 18. A set of wine blades 26, preferably configured as a single, continuous, spiral blade, is mounted on the shaft 24 inside the conduit 18 for drawing the wine 12 as a wine flow into the lower end region 20 in an upward direction toward the upper end region 22 of the conduit 18 upon rotation of the shaft 24. Preferably, a set of air blades 28, including a single blade, is mounted on the shaft 24 inside the conduit 18 for causing the air to move, by pushing or pulling, as an air stream into the upper end region 22 in a downward direction toward the lower end region 20 of the conduit 18 upon rotation of the shaft 24. A drive, preferably a single motor 30 powered by batteries 32, is operative for rotating the shaft 24, the wine blades 26 and the air blades 28 to propel the wine flow and the air stream against each other in a mutually countercurrent relationship and to commingle the wine flow and the air stream inside the bottle 14.

In a preferred embodiment, the conduit 18 has apertures 34 located intermediate the end regions 20, 22 of the conduit 18, and a set of radially extending fins 36 is mounted on the shaft 24 intermediate the end regions 20, 22 of the conduit 18. The fins 36 are rotatable with the shaft 24 for radially directing the wine flow by centrifugal force through the apertures 34 as wine droplets for commingling with the air stream.

In addition, the conduit 18 extends from a housing 38 having an annular mounting flange 40 for mounting within the neck 16 of the bottle 14 with a friction fit to support the housing 38 in a stable position on the bottle 14. The housing 38 has air inlets 42 and air outlets 44 to admit and discharge air respectively in and out of the bottle 14.

It will be understood that each of the elements described above, or two or more together, also may find a useful application in other types of constructions differing from the types described above.

For example, the conduit 18 can be a single piece tube and have a predetermined length, suitable to extend over most of the height of a particular bottle 14. Alternatively, the conduit 18 can comprise a number of tubular elements, which are telescopically joined, thereby allowing the length of the conduit 18 to be altered to fit the heights of various sized bottles having variable levels of wine contained therein, and also for ease of storage. Also, the drive need not be operated by DC batteries as shown, but could also be operated by rechargeable or solar batteries, or be electrically operated by an electrical power cable, or it can be mechanically operated.

While the invention has been illustrated and described as embodied in a wine aeration device and method, it is not intended to be limited to the details shown since various modifications and structural changes may be made without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A device for aerating wine in a bottle, comprising:
an elongated, upright conduit having a lower end region in fluid communication with the wine, and an upper end region;
a rotary shaft located within, and extending along, the conduit;
a wine blade on the shaft within the lower end region of the conduit and rotatable with the shaft;
an air inlet for admitting air into the upper end region of the conduit; and
a drive for rotating the shaft and the wine blade to draw the wine as a wine flow into the lower end region of the conduit in an upward direction toward the upper end region of the conduit into communication with the air admitted by the air inlet inside the bottle.

2. The device of claim 1, wherein the conduit has apertures intermediate the end regions, and wherein the wine flow passes through the apertures.

3. The device of claim 2, and a set of fins on the shaft within the conduit intermediate the end regions of the conduit, and rotatable with the shaft for radially directing the wine flow by centrifugal force through the apertures as wine droplets for commingling with the air admitted by the air inlet.

4. The device of claim 1, and a housing from which the conduit extends, and wherein the housing has an annular mounting flange for mounting within a neck of the bottle to support the housing on the bottle.

5. The device of claim 4, wherein the housing has an air outlet spaced from the air inlet.

6. The device of claim 1, and an air blade on the shaft within the conduit intermediate the end regions of the conduit, and rotatable with the shaft; and wherein the drive is operative for also rotating the air blade for causing the air to move as an air stream into the upper end region in a downward direction toward the lower end region of the conduit to propel the wine flow and the air stream against each other in a mutually countercurrent relationship and to commingle the wine flow and the air stream inside the bottle.

7. A device for aerating wine in a bottle, comprising:
an elongated, upright conduit having one end region in fluid communication with the wine, and an opposite end region in fluid communication with the atmosphere;
a rotary shaft located within, and extending along, the conduit;
a wine blade on the shaft within the conduit for drawing the wine as a wine flow into the one end region in an upward direction toward the opposite end region of the conduit upon rotation of the shaft;
an air blade on the shaft within the conduit for causing the air to move as an air stream into the opposite end region in a downward direction toward the one end region of the conduit upon rotation of the shaft; and
a drive for rotating the shaft, the wine blade and the air blade to propel the wine flow and the air stream against each other in a mutually countercurrent relationship and to commingle the wine flow and the air stream inside the bottle.

8. The device of claim 7, wherein the conduit has apertures intermediate the end regions, and wherein the commingled wine flow and air stream pass through the apertures.

9. The device of claim 7, wherein the wine blade is configured as a continuous spiral blade.

10. The device of claim 8, and a set of fins on the shaft intermediate the end regions of the conduit, and rotatable with the shaft for radially directing the wine flow by centrifugal force through the apertures as wine droplets for commingling with the air stream.

11. The device of claim 7, wherein the drive is a single motor.

12. The device of claim 7, and a housing from which the conduit extends, and wherein the housing has an annular mounting flange for mounting within a neck of the bottle to support the housing on the bottle.

13. The device of claim 12, wherein the housing has an air inlet in fluid communication with the opposite end region, and an air outlet for discharge of air from the bottle.

14. A method of aerating wine in a bottle, comprising the steps of:
immersing one end region of an elongated, upright conduit to be in fluid communication with the wine, and exposing an opposite end region of the conduit to be in fluid communication with the atmosphere;
locating a rotary shaft within, and extending the shaft along, the conduit;
drawing the wine as a wine flow into the one end region in an upward direction toward the opposite end region of the conduit upon rotation of a wine blade mounted on the shaft within the conduit;
admitting air into the opposite end region of the conduit; and
rotating the shaft and the wine blade to draw the wine as a wine flow into the one end region of the conduit in an upward direction toward the opposite end region of the conduit into communication with the air admitted into the bottle.

15. The method of claim 14, and passing the wine flow through apertures formed intermediate the end regions of the conduit.

16. The method of claim 15, and rotating a set of fins with the shaft intermediate the end regions of the conduit, for radially directing the wine flow by centrifugal force through the apertures as wine droplets for commingling with the air admitted into the bottle.

17. The method of claim 14, and extending the conduit from a housing, and mounting an annular mounting flange of the housing within a neck of the bottle to support the housing on the bottle.

18. The method of claim 14, wherein the admitting step is performed by causing the air to move as an air stream into the opposite end region in a downward direction toward the one end region of the conduit upon rotation of an air blade mounted on the shaft within the conduit; and wherein the rotating step is performed by also rotating the air blade to propel the wine flow and the air stream against each other in a mutually countercurrent relationship and to commingle the wine flow and the air stream inside the bottle.
